(19) United States
(12) Patent Application Publication
(10) Pub. No.: US 2012/0038761 A1
(43) Pub. Date: Feb. 16, 2012

(54) Microscope System

(75) Inventor: Ulrich Sander, Rebstein (CH)

(73) Assignee: LEICA MICROSYSTEMS (SCHWEIZ) AG, Heerbrugg (CH)

(21) Appl. No.: 13/206,751

(22) Filed: Aug. 10, 2011

(30) Foreign Application Priority Data
Aug. 12, 2010 (DE) 10 2010 039 289.8

(51) Int. Cl. H04N 7/18

(52) U.S. Cl. 348/67; 348/E07.085

(57) ABSTRACT

The invention concerns a microscope system (100) comprising a surgical microscope (101), to generate a microscopic image, a laser scanning endoscope (102), to generate an endoscopic image, a reflection device to reflect representations into the microscopic image, and comprising a detector (103), which establishes a position of the endoscope (102) and generates corresponding position data.

### CROSS REFERENCE TO RELATED APPLICATIONS

This application claims priority of German patent application number 10 2010 039 289.8 filed Aug. 12, 2010, the entire disclosure of which is incorporated by reference herein.

### FIELD OF THE INVENTION

The present invention concerns a microscope system including an optical microscope, an endoscope and a data reflection device, and a microscopy method using such a microscope system.

### BACKGROUND OF THE INVENTION

The invention is described below mainly with reference to surgical microscopes, but is not restricted to this specific application. A microscope system according to the invention is also suitable inter alia for material testing, for example.

Microscope systems which have a surgical microscope and an endoscope are known. The magnification which the endoscope can achieve is comparable to that of the microscope, but the endoscope also allows observation of inaccessible places.

Simultaneous presentation of an endoscope image and a microscope image is described in EP 0 951 861 A1, for example. The user can observe, in the surgical microscope, the endoscope image next to the microscope image, and optionally data and images of the object or patient, for example concerning the patient's heart data. If the image field of the endoscope does not correspond to that of the microscope in terms of location, the position of the endoscope or the endoscope tip must be moved manually.

Another presentation form of a combined microscope and endoscope image is presented in the publication “Stereoscopic Ophthalmic Microendoscope System”, Arch Ophthalmol/Vol. 125, October 1997. In this case, a microscope system which optically presents the two images simultaneously is described. In the case of this microscope system, the endoscope image is not shown on a screen, but reflected directly into the beam path of the microscope. The endoscope image can be overlaid over the microscope image.

The devices of the prior art have the disadvantage that in the case of simultaneous presentation of a microscope image and an endoscope image, the object details mostly do not agree. Thus the situation often occurs that the endoscope image does not show, or only shows in part, the detail which is to be observed through the microscope. It is also not readily possible for the operator to locate the location shown by the endoscope in the microscope image. Therefore, the microscope and endoscope are basically used independently of each other.

### SUMMARY OF THE INVENTION

It is therefore desirable to develop a microscope system in which the co-operation of endoscope and microscope is improved. This is achieved by a microscope system having the features described herein.

The invention is based on providing a microscope system comprising a surgical microscope, a laser scanning endoscope (often termed as a confocal laser endomicroscope), a reflection device and a detector, which determines the spatial position of the tip of the laser scanning endoscope, preferably relative to a defined reference point, and generates corresponding position data. The spatial position is preferably determined according to DE 10 2007 009 543 A1 (corresponding to U.S. Pub. No. 2008/0204864, the entire disclosure of which is incorporated by reference herein). In this case, acceleration sensors are fixed to the endoscope. By means of the acceleration sensors, six co-ordinates concerning the position of the endoscope can be captured, i.e. three spatial co-ordinates and additionally three associated angular co-ordinates. Using acceleration sensors, the respective position in space of the endoscope tip of the microscope system according to the invention can be determined. The position can also be determined using optical methods, for example cameras. Other possibilities for position detection are disclosed in U.S. Pat. No. 6,434,416 B1 (the entire disclosure of which is incorporated by reference herein), in which automatic movement of a surgical instrument on the basis of the determined position is described. By means of a reflection device, for example according to EP 1 224 499 B1 (corresponding to U.S. Pat. No. 6,434,416, the entire disclosure of which is incorporated by reference herein), the position of the endoscope tip can be displayed in the microscope image.

The invention offers a number of advantages, which above all are particularly effective in combination. First, the detector makes it possible to detect and display the position of the endoscope tip in the microscope image. Next, the use of a laser scanning endoscope makes it possible to provide, in addition to the microscope image, an endoscope image with a much higher magnification. For example, traditional surgical microscopes have a magnification of about fourfold to about fortyfold, whereas laser scanning endoscopes resolve into the sub-micrometer range. The combination for the first time of devices with such different resolving power offers particular advantages. Detailed observation through the endoscope can be linked to an overview through the microscope, in which case the location of the detail can be displayed in the microscope image. Details which are investigated and characterised using the laser scanning endoscope can be identified in the overview image.

A laser scanning endoscope lies in the field of confocal laser microscopes. The specific field is often termed as confocal laser endomicroscopy. For further details reference is made to U.S. Pub. No. 2005/0078924 A1 (the entire disclosure of which is incorporated by reference herein), U.S. Pub. No. 2005/0207668 A1 (the entire disclosure of which is incorporated by reference herein), or WO 2011033390 A1 (claiming priority to U.S. Prov. No. 61/243,425, the entire disclosures of WO 2011033390 A1 and U.S. Prov. No. 61/243,425 are hereby incorporated by reference in their entirety).

A microscope system according to the invention is suitable, for example, for material investigations, in which the endoscope image is used to assess the material itself and the microscope image is used for orientation and overview.

A microscope system according to the invention displays particular advantages in the medical field. If a laser scanning endoscope and a position detector are combined with a surgical microscope, the endoscope can be used in particular for investigating the cell structure, for example to identify particular tissue regions in the microscope image. The laser scanning endoscope offers the possibility of resolving the cell structure and thus, for example, making it possible to distinguish healthy and unhealthy tissue. For this purpose, the endoscope image can advantageously also be transmitted to a remote location, for example a pathology laboratory. The position detector offers the possibility of identifying correspondingly characterised tissue in the microscope image which is used as the image field for operations.

Use of a microscope system according to the invention in the medical field is particularly well tolerated by patients. Healthy and unhealthy tissue can be distinguished quickly and reliably. Nowadays, tissue characterisation is usually carried out using fluorescence microscopy and instantaneous sections. Both methods are relatively stressful for the patient. For fluorescence microscopy, the patient must ingest marker chemicals, which often have strong side effects. Additionally, exact delimitation between healthy and unhealthy tissue is impossible by this method, so that usually too much or too little tissue is removed, and both with unpleasant consequences in each case. In the case of instantaneous sections, removed tissue is investigated, which is also very stressful for the patient and in principle also results in the removal of healthy tissue.

In contrast, visual delimitation of healthy and unhealthy tissue, which is made possible by the invention, requires no additional intervention and is thus particularly well tolerated.

Additionally, according to an embodiment of the invention, it is intended that a first computing unit, which receives the position data of the detector and determines the position of the endoscope tip relative to the microscopic image, should be provided on the microscope system. Then the respective position data and/or the positions which were determined relative to the microscopic image can be stored by the first computing unit.

In addition to the first computing unit, a display unit can be added to the microscope system, to display the positions of the endoscope tip, which are prepared and stored, in part, in the computing unit, in the microscopic image. The display unit can display both current and stored position data of the endoscope tip in the microscopic image. In this way, it is possible to reproduce the various endoscope tip positions in the microscope image by means of a line, curve or even an area.

A combined image consisting of an endoscopic and a microscopic image is preferably generated by means of the reflection device. The endoscopic image is reflected by means of the reflection device into the beam path of the microscope. For the observer of the combined image, it is advantageous both to see the fine structure of the image received by the endoscope and to obtain the overview through the microscope image. Advantageously, the endoscopic image, alternatively or in addition to overlaying with the microscopic image, is shown in a separate portion, separately from the microscopic image. The operator can thus operate the endoscope directly, without having to look up from the microscope.

In a further embodiment, a handling device and also a second computing unit belong to the microscope system according to the invention. The handling device which is connected to the microscope system is preferably a joystick. The user is thus able to position the endoscope tip in a precisely targeted manner over the object or within the object.

The second computing unit is expediently set up to insert and/or store the detector's position data, which have been prepared, determined and optionally stored by means of the first computing unit, in image data of a CT image. In this way, it is possible to reproduce the various endoscope tip positions in the CT image, too, by means of a line, curve or even an area.

Mapping the position data within a microscope image or CT image causes the marking of locations which are captured using the endoscope and identified by the user. A surgeon is thus able, for example, to distinguish tissue to be removed unambiguously from tissue which is not to be removed. In comparison with the systems and methods of the prior art, the preferred microscope system is thus able to make a more precise delimitation between tissue to be removed and tissue which is not to be removed, so that as little healthy tissue as possible has to be removed.

On the basis of the detection of the position of the endoscope tip relative to a reference point in space, for example relative to the position of the microscope, the position of the endoscope tip can be displayed exactly in the microscopic image and/or the CT image.

On the basis of the calculated position data of the endoscope tip, it is possible for the user of the microscope system, in particular the surgeon, to position the endoscope in a precisely targeted manner at the location of the object which the surgeon is observing through the microscope at this moment. No preparation time or in particular waiting time is necessary to match the two images to each other, so that the operation can begin immediately. This is a great advantage, since the operations are mostly very difficult brain or eye operations.

Further advantages and embodiments of the invention are given in the description and the attached drawing.

It will be understood that the above-mentioned features and those which are still to be explained below can be used not only in the stated combination but also in other combinations or alone, without departing from the scope of the present invention.

The invention is shown schematically in the drawing on the basis of an embodiment, and is described in detail below with reference to the drawing.

### BRIEF DESCRIPTION OF THE DRAWINGS

FIG. 1 shows a schematic representation of a preferred embodiment of a microscope system according to the invention.

### DETAILED DESCRIPTION OF THE INVENTION

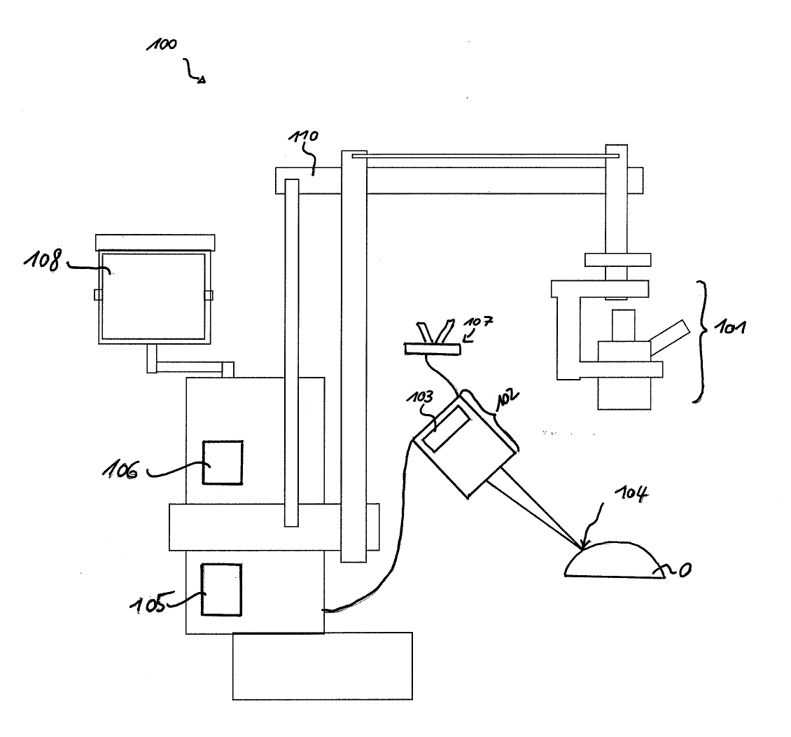

In FIG. 1, a preferred microscope system is shown schematically and identified as a whole by 100. In the preferred embodiment, the microscope system 100 has a surgical microscope 101, a laser scanning endoscope 102 with a detector 103, a reflection device (not shown), a first computing unit 105, a second computing unit 106 and a display unit 108.

The surgical microscope 101 can be orientated by means of a stand 110 so that the observer can see the object O through the microscope. The stand 110 can both consist of a stand foot and a stand body and have a construction in which the microscope is carried by a suspended stand which projects from the ceiling of an operating theatre.

The laser scanning endoscope 102 is also attached to a stand or pedestal (not shown). In particular, the tip of the endoscope 102 can penetrate the object O or draw very close to the object O, in particular the surface thereof to be observed. A detector 103, which is provided on the endoscope 102, detects the position of the tip 104 of the endoscope 102 relative to a defined reference point in space.

A handling device in the form of a joystick 107, with which the user or surgeon can place the endoscope tip 104 exactly at a desired location on or in the object O, is also connected to the endoscope 102. The joystick 107 corresponds for example to a construction which is known from the prior art.

The first computing unit 105, the second computing unit 106 and the display unit 108 are connected both to each other and directly or indirectly to the endoscope 102 and the surgical microscope 101. The first and second computing units can also be identical.

One or more memory devices, in which the current position data of the endoscope tip relative to the microscopic image and/or to a stored CT image are stored, are associated with the first and/or second computing unit 105, 106.

On the surgical microscope 101 itself, on the stand or connected to the surgical microscope 101, there is a control unit (not shown) for operation by the surgeon, in particular to trigger storage of the current position of the endoscope tip 104.

If the surgeon observes the object O through the surgical microscope 101, he or she sees, by reflection, a combined image of a microscopic image of a first magnification and an endoscopic image of a second, significantly higher magnification. Simultaneously, in the microscopic image the position of the endoscope tip 104 is indicated as a marking, for example in the form of a dot. If the endoscope tip 104 is at a suitable location on the object O, the surgeon, by operating the control unit, can trigger the storage of the position. For example, the surgeon can select positions to be stored, for example unhealthy tissue, on the basis of the endoscope image. The surgeon can particularly easily change the position of the endoscope tip 102 by handling a joystick 107.

After the surgeon has triggered a plurality of storage tasks for respective position data by operating the control unit, the respective stored position data can be shown in the microscope and/or on the display unit 108 in the form of a line, curve or area in the microscopic image. For example, the surgeon can see a marked region which is to be removed during an operation.

In an exemplary use of the microscope system according to the invention for removing unhealthy tissue, first exposed regions are investigated using the endoscope, and unhealthy tissue is identified. Then the identified regions are removed under the microscope. The regions which thus appear are then investigated again using the endoscope, etc.

There is also the possibility for the surgeon of storing the position data, by means of a second computing unit 106, in image data of a CT image. This prepared CT image, optionally together with further data about the patient, can be shown on the display unit 108.

Marking a particular tissue detail makes it easier for the surgeon to distinguish between healthy and unhealthy tissue, in particular during an operation.

Below, an advantageous possible use of the microscope system 100 according to the invention in a material investigation will be described. A component O to be investigated is arranged under the optical microscope 101 of the microscope system. The laser scanning endoscope 102, i.e. its tip 104, is guided onto the component, to detect defects such as hairline cracks or the like. Detected defects can then be marked in the microscope image, to obtain an overview of damaged regions, for example.

Although the present invention has been described with respect to one or more particular embodiments, it will be understood that other embodiments of the present invention may be made without departing from the spirit and scope of the present invention.

What is claimed is:

1. A microscope system (100), comprising:
an optical microscope (101) to generate a microscopic image having a first magnification;
a laser scanning endoscope (102) to generate an endoscopic image having a second magnification;
a reflection device to reflect representations into the microscopic image;
a detector (103) to establish a position of the endoscope (102) and generate corresponding position data; and
a first computing unit (105) to determine the position of the tip (104) of the endoscope (102) relative to the microscopic image from the position data of the detector (103);
wherein the reflection device displays the position of the endoscope tip (104) in the microscopic image.

2. The microscope system according to claim 1, wherein the reflection device is arranged to reflect the endoscopic image into the microscopic image.

3. The microscope system according to claim 1, wherein the first computing unit (105) stores the respective position data and/or the position of the endoscope tip (104) relative to the microscopic image after receiving a storage command.

4. The microscope system according to claim 3, further comprising a control unit, operation of which sends the storage command to the first computing unit (105).

5. The microscope system according to claim 4, further comprising a display unit (108) connected to the first computing unit (105) to display the position of the endoscope tip (104) in the microscopic image.

6. The microscope system according to claim 5, wherein the display unit (108) displays the respective stored positions of the endoscope tip (104) in the microscopic image.

7. The microscope system according to claim 1, wherein the reflection device is arranged to reflect the endoscopic image into a separate portion, separately from the microscopic image.

8. The microscope system according to claim 1, further comprising a handling device (107) connected to the endoscope (102), wherein the handling device (107) changes the position of the endoscope tip (104) through handling by a user.

9. The microscope system according to claim 1, further comprising a second computing unit (106), connected to the microscope (101) and endoscope (102) and configured to store the current and/or respective stored position data and/or positions of the endoscope tip (104) relative to the microscopic image, positioned in the image data of a CT image.

10. A microscopy method, comprising:
(A) providing a microscope system (100), comprising:
an optical microscope (101) to generate a microscopic image having a first magnification;
a laser scanning endoscope (102), to generate an endoscopic image having a second magnification;
a reflection device to reflect representations into the microscopic image;
a detector (103) to establish a position of the endoscope (102) and generate corresponding position data; and
a first computing unit (105) to determine the position of the tip (104) of the endoscope (102) relative to the microscopic image from the position data of the detector (103);
wherein the reflection device displays the position of the endoscope tip (104) in the microscopic image;
(B) detecting a position of the endoscope tip (104);
(C) generating position data from the detected position of the endoscope tip (104);
(D) determining a position of the endoscope tip (104) relative to the microscopic image from the generated position data; and
(E) displaying the position of the endoscope tip (104) in the microscopic image.

11. The microscopy method according to claim 10, wherein the position data of the endoscope (102) is stored in image data of a CT image by means of a second computing unit (106).

12. The microscopy method according to claim 10, wherein a line, curve or area is displayed by linking multiple stored position data in the microscopic image and/or CT image.
